(19) United States
(12) Patent Application Publication
(10) Pub. No.: US 2005/0224044 A1
(43) Pub. Date: Oct. 13, 2005

(54) Injection strategy for low noise and soot combustion

(76) Inventors: Boris D. Stojkovic, Ann Arbor, MI (US); Forrest A. Jehlik, Royal Oak, MI (US); Sherif H. El Tahry, Troy, MI (US); Roger B. Krieger, Birmingham, MI (US)

Correspondence Address: KATHRYN A MARRA;General Motors Corporation, Legal Staff, Mail Code 482-C23-B21, P.O. Box 300, Detroit, MI, 48265-3000, US

(21) Appl. No.: 10/967,890

(22) Filed: Oct. 18, 2004

Related U.S. Application Data
(60) Provisional application No. 60/560,455, filed on Apr. 8, 2004.

(51) Int. Cl. F02B 17/00; F02B 31/00

(52) U.S. Cl. 123/299; 123/301

(57) ABSTRACT

The present invention, provides a strategy or method for injecting fuel in two distinct fuel injection events per engine cycle. The first injection event is main fuel injection, which occurs when the crankshaft is near top-dead center. The main injection event delivers a majority of the fuel needed to provide a majority of the power produced during combustion. The second injection event is post injection, which occurs shortly after the main fuel injection event. The post injection event provides a supplemental amount of fuel to the combustion chamber to reduce the rate of pressure rise while increasing, turbulence, mixing and cylinder pressure within the combustion chamber to reduce the formation of soot. In addition, the combination of the main fuel injection event and the post fuel injection event reduces engine noise by reducing heat release rates and the rate of combustion chamber pressurization.

### CROSS-REFERENCE TO RELATED APPLICATIONS

This application claims priority from U.S. Provisional Patent Application No. 60/560,455 filed Apr. 8, 2004.

### TECHNICAL FIELD

This invention relates to diesel fuel injection methods and, more particularly, to a method of delivering multiple fuel injections into a combustion chamber to minimize engine noise and soot.

### BACKGROUND OF THE INVENTION

A four-stroke diesel engine cycle conventionally includes intake, compression, expansion and exhaust strokes. Intake air drawn into a combustion chamber on the intake stroke is compressed during the subsequent compression stroke. Fuel is then injected into the combustion chamber and ignited by the hot compressed gases. Burning of the fuel within the combustion chamber generates heat and pressure, which produces power on the expansion stroke. Combustion products are exhausted during the exhaust stroke. Fuel injection timing and ignition lag with high rates of pressure rise can cause excessive engine noise while advanced ignition and burning of unvaporized fuel droplets will increase the formation of soot.

Fuel may be delivered to combustion chambers with fuel injectors, controlled by an engine control module (ECM) interfacing with the injectors and a crankshaft position sensor, which relays crankshaft angle information to the ECM. Based upon crankshaft angle, the ECM determines injector timing. However, it should be understood that other types of fuel injection control may be employed.

It is known to reduce engine noise by providing a pilot injection of fuel prior to a main, load producing, injection event to reduce ignition delay of the main injection. Pilot injection provides a modest injection of fuel into an engine combustion chamber to initiate combustion. As the pilot fuel is injected into the combustion chamber, the pilot fuel ignites, thereby increasing the pool of reactive radicals within the combustion chamber to reduce ignition delay of subsequently injected fuel. Shortly after pilot injection, a main fuel injection event occurs. As the main fuel is injected into the combustion chamber, the reactive radicals, generated by the pilot fuel, reduce ignition delay of the main fuel injection, reducing the rate of pressure rise within the combustion chamber and developing power while reducing engine noise.

A drawback to pilot injection is that the mixing time of the main fuel injection event is reduced, resulting in fuel rich regions within the combustion chamber which yield undesirable soot particle emissions.

### SUMMARY OF THE INVENTION

In the present invention, a new fuel injection method is provided to reduce engine noise and soot. The method provides two distinct fuel injection events, every combustion chamber cycle.

The first injection event delivers a sufficient amount of fuel into a combustion chamber to initiate a load producing main fuel combustion event within the combustion chamber. The second post injection event delivers a sufficient amount of fuel into the combustion chamber, shortly after the main fuel injection event, to increase mixing turbulence, pressure and temperature within the combustion chamber and reduce soot formation and engine noise.

The combination of the main fuel injection event and the post injection event reduces engine noise apparently by reducing the rates of combustion pressure rise and heat release. In addition, combustion chamber turbulence, resulting from post injection, is believed to aid mixing of fuel rich portions within the combustion chamber and thereby improve fuel oxidation and reduce the formation of soot.

These and other features and advantages of the invention will be more fully understood from the following description of certain specific embodiments of the invention taken together with the accompanying drawings.

### BRIEF DESCRIPTION OF THE DRAWINGS

FIG. 1 is a graph illustrating injector timing and cylinder pressures versus piston crank angle for a pilot injection method compared with a post injection method according to the present invention;

FIG. 2 is a graph illustrating heat release rates for the methods of FIG. 1;

FIG. 3 is a graph illustrating the effect of post injection energizing fuel injection time on engine noise; and

FIG. 4 is a graph illustrating the effect of post injection energizing fuel injection time on engine soot emissions.

### DESCRIPTION OF THE PREFERRED EMBODIMENT

The present invention, provides a novel strategy or method by injecting fuel in two distinct fuel injection events per engine cycle. The first injection event is main fuel injection, which occurs when the crankshaft is near top-dead center. The main injection event delivers a majority of the fuel needed to provide a majority of the power produced during combustion.

The second injection event is post injection, which occurs shortly after the main fuel injection event. The post injection event provides a supplemental amount of fuel to the combustion chamber to reduce the rate of pressure rise while increasing, turbulence, mixing and cylinder pressure within the combustion chamber.

In operation, intake air drawn in and compressed by a piston within each combustion chamber. As the piston nears top dead center, and the crankshaft angle approaches 0 degrees, an ECM actuates the fuel injector to initiate the main fuel injection event which injects between 80 and 95% of the total fuel injected into the combustion chamber during one cycle of the engine. Preferably, the main injection event occurs between −2 degrees and 6 degrees of crank angle. This fuel vaporizes in the hot compressed air within the combustion chamber and after a delay ignites to create a period of uncontrolled combustion and expansion which produce heat and power.

Once the main injection event is completed, the ECM stops injection, for approximately 4 degrees of crank angle. As the crank angle approaches 10 degrees, the ECM initiates post injection, through the fuel injector, to deliver the remainder of the fuel to the combustion chamber. This is typically between 5 and 20% of the total fuel injected into the combustion chamber, during the expansion cycle of the engine.

The post injection fuel apparently increases turbulence and mixing within the combustion chamber to effectively dilute and oxidize fuel rich regions within the combustion chamber and thereby reduce soot. Post injection also provides evaporative cooling of the gases within the combustion chamber to reduce the rate of pressurization.

The combination of the main fuel injection event and the post injection event reduces the rate of pressure raise and the rate of heat release within the combustion chamber, which is effective to reduce engine noise as evidenced by the following graphs.

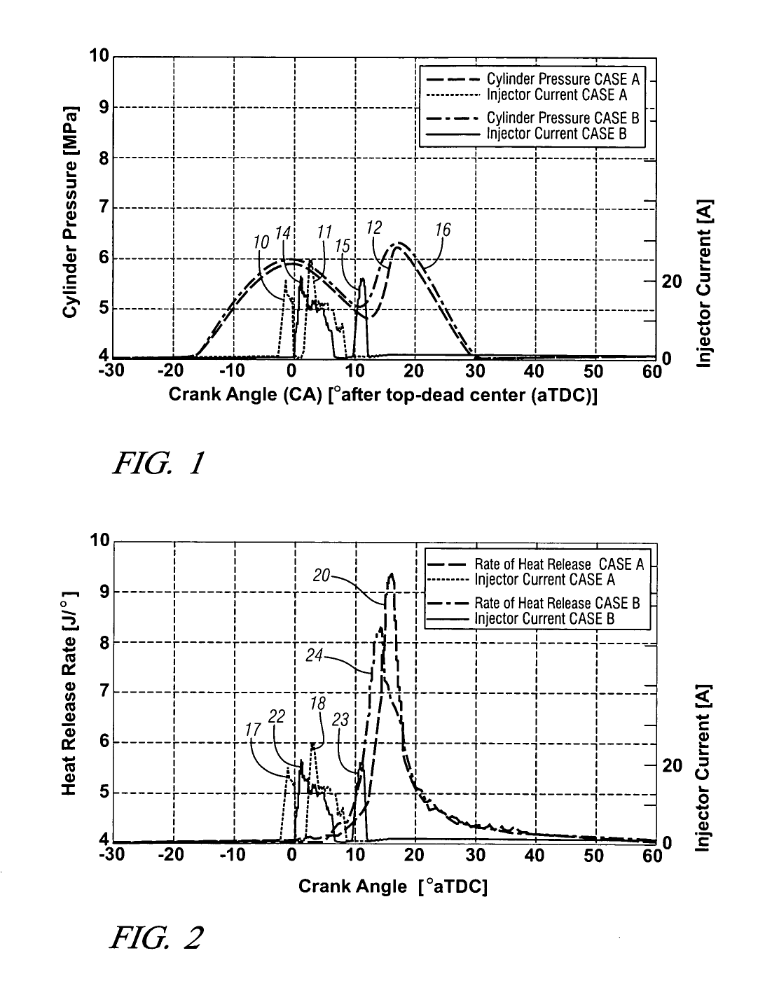

FIG. 1 is a graph of cylinder pressure versus injector current. Dashed lines 10 and 11 (injector current case A) represent a prior art fuel injection method employing pilot injection and main fuel injection. Line 10 indicates fuel injection current during pilot injection while line 11 represents fuel injection current during main injection. Line 12 (cylinder pressure case A) illustrates corresponding cylinder pressure when the fuel injection methods of dashed lines 10 and 11 are employed.

Solid lines 14 and 15 (injector current case B) represent fuel injector current according to one exemplary injection timing method of the present invention. Line 14, represents main fuel injection activity, which occurs between 0 and 6 degrees. Line 15 represents post fuel injection activity, beginning at 10. Solid line 16 (cylinder pressure case A) illustrates combustion chamber pressure corresponding with the fuel injection events of lines 14 and 15.

Line 16 is impacted by post injection in that it generally shows a smaller rate of pressure rise, between 10 and 15 degrees, than the prior art represented by dashed line 12. This smaller rate of pressure rise is believed to result in the reduced engine noise as compared to the prior art. It should be understood that these values are only exemplary and will be varied to suit the particular conditions of a particular engine embodiment.

FIG. 2 is a graph of injector current versus heat release. Dashed lines 17 and 18 (injector current case A) represent prior art fuel injection which employs pilot fuel injection and main fuel injection. Line 17 represents fuel injection current during pilot injection and line 18 represents fuel injection current during main injection. Dashed line 20 (cylinder pressure case A) illustrates heat release over a period of time which corresponds with the injection activity of dashed lines 17 and 18. Solid lines 22 and 23 (injector current case B) represent fuel injector current according to the exemplary method of the present invention, shown in FIG. 1. Line 22 illustrates the main injection event, occurring between 0 and 6 degrees, and line 23 illustrates the post injection event, occurring after 10 degrees. Solid line 24 (cylinder pressure case B) illustrates the rate of heat release which corresponds with the fuel injection events of lines 17 and 18.

Line 24 is impacted by post injection in that it shows a lower peak of heat release and a lower rate of heat release, between 10 and 20 degrees, than the prior art represented by dashed line 20. This lower peak of heat release and lower rate of heat release is also believed to produce quieter engine operation over the prior art. The post fuel injection event is also believed to result in more complete combustion of soot particles in the burning gases. It should be understood that these values are only exemplary and will be varied to suit the particular conditions of a particular engine embodiment.

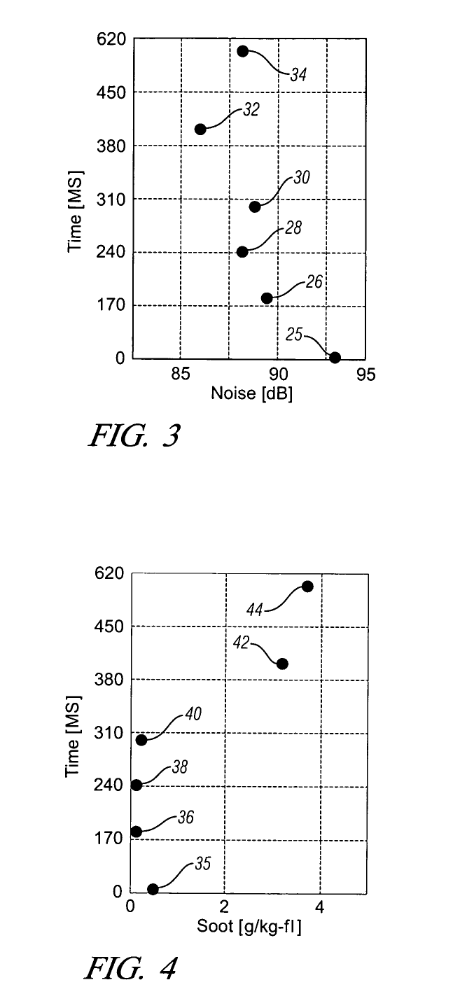

FIG. 3 is a graph showing the effect of post injection energizing time on engine noise at a fixed dwell time, 300 microseconds (μs) after the main injection event. Energizing time is varied from 180 to 500 μs, and is proportional to the amount of fuel injected during the post injection event. Each point represents an average of 300 engine cycles obtained at steady-state speed and load conditions.

Point 25 of the chart, shows 93 decibels (dB) of engine noise produced during combustion with conventional pilot injection. Point 26 of the chart, shows approximately 89 dB of engine noise produced during combustion when post injection is energized for approximately 170 μs. Point 28 illustrates approximately 87.5 dB of engine noise produced during combustion when post injection is energized for approximately 240 μs. At 240 μs the main to post fuel injection split is approximately 90%:10%.

Point 30 shows approximately 88 dB of engine noise produced during combustion when post injection is energized for approximately 305 μs. Point 32 illustrates approximately 86 dB of engine noise produced during combustion when post injection is energized for approximately 390 μs. Point 34 shows approximately 87 dB of engine noise produced during combustion when post injection is energized for approximately 470 μs.

Accordingly, it has been found in this particular application, that a post injection time of around 390 μs provides the best results for reducing engine noise. It should be understood that these values may be varied by the conditions of a particular engine embodiment.

FIG. 4 is a graph showing the effect of post injection energizing time on soot production, in grams of soot per kilograms of fuel (g/kg-fl), at a fixed dwell time 300 μs after the main injection event. Energizing time is varied from 180 to 500 μs, and is proportional to the amount of fuel injected during the post injection event. Each point represents an average of 300 engine cycles obtained at steady-state speed and load conditions.

Point 35 represents soot formation with conventional pilot injection. Points 36, 38 and 40 illustrate optimal post fuel injection timing, between 170 and 310 μs, for reducing soot. Points 42 and 44 illustrate less desirable post fuel injection timing, between 380 and 450 μs.

Considering the results of FIGS. 3 and 4, the preferred injector energizing time is approximately 240 μs. At this time, the lowest possible soot levels are obtained while the amount of engine noise is dramatically reduced over the prior art. However, it should be understood that this timing may vary depending upon various conditions of a particular engine embodiment.

While the invention has been described by reference to certain preferred embodiments, it should be understood that numerous changes could be made within the spirit and scope of the inventive concepts described. Accordingly, it is intended that the invention not be limited to the disclosed embodiments, but that it have the full scope permitted by the language of the following claims.

1. A method of operating a direct injection compression ignition internal combustion diesel engine, having a combustion chamber operative through compression, fuel injection, combustion and expansion events for producing power, the method comprising the steps of:
compressing an air charge in the combustion chamber to a diesel fuel self ignition temperature and pressure;
injecting a main diesel fuel charge beginning near the end of the compression step;
after a dwell period, injecting a smaller post injection fuel charge during an early portion of combustion of the main fuel charge; and
completing combustion and expanding the combustion chamber to provide power;
the conditions of the steps being such as to initiate combustion of the main charge near the end of the compression step and to inject the post injection fuel charge early in combustion of the main fuel charge, whereby the heat release rate and engine noise are reduced and residual soot formation in the combustion events is minimized.

2. A method as in claim 1 wherein the main fuel injection event delivers between 80% and 95% of the total fuel injected into the combustion chamber during an engine cycle.

3. A method as in claim 1 wherein the post fuel injection event delivers between 5% and 20% of the total fuel injected into the combustion chamber during an engine cycle.

4. A method as in claim 1 wherein the main fuel injection event occurs between −5 and 10 degrees of crank angle.

5. A method as in claim 1 wherein the post fuel injection event occurs between 5 and 15 degrees of crank angle.

6. A method as in claim 1 wherein the energizing time of post fuel injection is between 150 and 500 μs.
